(19) United States
(12) Patent Application Publication
(10) Pub. No.: US 2023/0409748 A1
(43) Pub. Date: Dec. 21, 2023

(54) GARBLING ENHANCEMENTS

(71) Applicant: VMware, Inc., Palo Alto, CA (US)

(72) Inventor: Avishay YANAI, Herzliya (IL)

(21) Appl. No.: 17/807,758

(22) Filed: Jun. 20, 2022

(51) Int. Cl. G06F 21/62; G06F 21/64

(52) U.S. Cl. CPC G06F 21/6254; G06F 21/645

(57) ABSTRACT

The disclosure provides an approach for data security. Embodiments include determining, by one or more garbling components running on one or more processing devices, first labels K^{a}₀ and K^{a}₁ representing values of 0 and 1 for a first input wire a of a gate g in a circuit, second labels K^{b}₀ and K^{b}₁ representing the values of 0 and 1 for a second input wire b of the gate g, and third labels K^{c}₀ and K^{c}₁ representing the values of 0 and 1 for an output wire c of the gate g. Embodiments include defining, by the one or more garbling components, four interpolation points based on K^{a}₀, K^{a}₁, K^{b}₀, K^{b}₁, K^{c}₀, and K^{c}₁ and determining, by the garbling component, using polynomial interpolation based on the four interpolation points, a polynomial P_{g} representing a garbled gate corresponding to gate g.

### BACKGROUND

Data security is a critically important objective for computing applications, particularly as processing and storage of data are increasingly distributed across multiple computing devices. For example, cloud services may be utilized to efficiently and conveniently process and/or store data. However, transmitting data to cloud services or other computing entities for such purposes introduces many opportunities for sensitive data to be compromised.

While there are many existing techniques for secure transmission, processing, and storage of data, these techniques tend to require large amounts of computing resources. For example, existing encryption and decryption techniques and other types of data security algorithms tend to be computationally expensive. As such, there is a need in the art for improved data security techniques.

### BRIEF DESCRIPTION OF THE DRAWINGS

FIG. 1 illustrates example computing components related to data security.

FIG. 2 illustrates an example related to an improved garbling algorithm for data security.

FIG. 3 illustrates an additional example related to an improved garbling algorithm for data security.

FIG. 4 depicts example operations related to data security.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

The present disclosure provides an approach for improved data security, particularly through an improved garbling algorithm for secure computation of data.

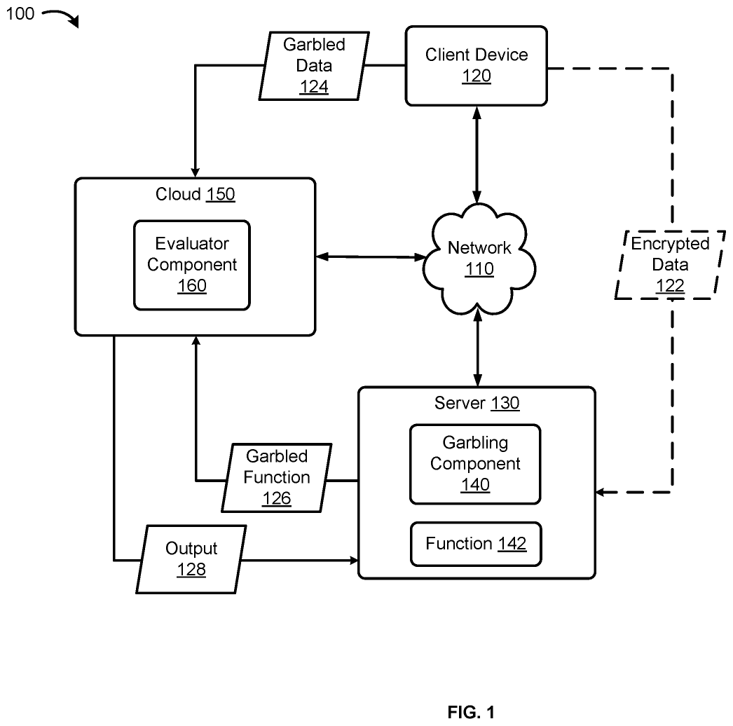

Secure computation is a problem in which N distrustful parties P₁, . . . , P_{N} hold private inputs x₁, . . . , x_{N} and want to compute some function ƒ(⋅) on these inputs without revealing anything about the inputs except the output of the function. For example, as described in more detail below with respect to FIG. 1, users of one or more computing devices that intend to utilize one or more remote computing components for processing sensitive data may have an objective of not allowing the one or more remote computing components to access the sensitive data.

### Overview of Garbling Techniques

One existing solution for secure computation is ‘garbling’. Specifically, given two parties P₁ and P₂ with inputs x₁ and x₂ respectively, P₁ may be considered the ‘garbler’ and P₂ may be considered the ‘evaluator’. At a high level, the garbler takes the function ƒ( ) and constructs a new function ƒ′ that preserves the functionality off but also preserves the privacy of the inputs. Then, the garbler transforms its input x₁ into a ‘garbled’ input x′₁ and also helps the evaluator to transform its input x₂ into a ‘garbled’ input x′₂. The garbler sends ƒ′ and x′₁ to the evaluator, which already has x′₂. Finally, the evaluator evaluates ƒ′ (x′₁, x′₂) to obtain the output y. When both parties are honest it is guaranteed that ƒ′ (x′₁, x′₂)=ƒ(x₁, x₂). It is also guaranteed that the parties do not learn anything that they do not initially know about x₁ or x₂ beyond the output ƒ(x₁, x₂).

However, ƒ is not a simple function, but rather a Boolean circuit that may include AND (A) and XOR (Y) logical gates. For a, b∈{0, 1} it is known that ∧(a, b)=1 iff (if and only if) a=b=1 and that ∧(a, b)=0 otherwise. Similarly it is known that ∨(a, b)=0 iff a=b=0 and ∨(a, b)=1 otherwise.

An example of an existing garbling scheme is Yao's garbled circuit, introduced by Andrew Yao in 1986. In Yao's garbled circuit, the garbler picks two random strings, also called labels, for every wire in the circuit. For the j-th wire, its random labels are denoted by K^{j}₀ and K^{j}₁, which represent the bits 0 and 1, respectively. On their own, Kⱼ⁰ and K^{j}₁ look the same, as both are random strings. Only the garbler knows that K^{j}₀ represents 0 and K^{j}₁ represents 1.

For gate g in the circuit, g(⋅) represents the function of the gate. The input wires of g are a and b and the output wire of g is c. In Yao's garbling algorithm, the garbler computes the following four ciphertexts ct₀₀, ct₀₁, ct₁₀, ct₁₁:

ct₀₀=Enc(K^{a}₀,Enc(K^{b}₀,K^{c}_{g(0,0)}))

ct₀₁=Enc(K^{a}₀,Enc(K^{b}₁,K^{c}_{g(0,1)}))

ct₁₀=Enc(K^{a}₁,Enc(K^{b}₀,K^{c}_{g(1,0)}))

ct₁₁=Enc(K^{a}₁,Enc(K^{b}₁,K^{c}_{g(1,1)}))

“EnC” represents an encryption function. For example, if g=∧ then ct₀₀ is an encryption of K^{c}₀ using keys K^{a}₀ and K^{b}₀. The garbler sets the garbled gate g′ to be the values {ct₀₀, ct₀₁, ct₁₀, ct₁₁} in a random order. For each gate g, the garbler sends the garbled gate g′ to the evaluator. For every circuit-output wire j, the garbler sends the map mapⱼ={K^{j}₀=0, K^{j}₁=1} to the evaluator.

For every input wire j, the evaluator obtains one label (either K^{j}₀ or K^{j}₁, but not both). Specifically, xⱼ is the private input to that wire j (known by either the garbler or the evaluator), and the evaluator obtains the label K^{j}ₓⱼ. The evaluator may obtain this label in a variety of ways known in the art (without the garbler knowing what the evaluator obtained).

The evaluator evaluates the garbled circuit in a gate by gate fashion. It begins by having a single label (used as a key) for each input wire. The key for wire j is K^{j} (it is noted that the evaluator does not necessarily know whether K^{j}=K^{j}₀ or K^{j}=K^{j}₁). For each gate g (in a topological order), a, b are its input wires and c is its output wire. Furthermore, g′={ct₁, ct₂, ct₃, ct₄} is the garbled gate given to the evaluator. The evaluator attempts to decrypt the ciphertexts one by one, until the decryption succeeds (it is guaranteed, with high probability, to succeed in exactly one of the attempts). If the decryption succeeds for ctᵢ, then the evaluator sets K^{c}=Dec(K^{a}, Dec(K^{b}, ctᵢ)). “Dec” represents a decryption function.

For each circuit-output wire j, the evaluator computes the bit yⱼ=map(K^{j}). Finally, the evaluator outputs the evaluation y=(yⱼ₁, . . . , yⱼₘ), where j1, . . . , jm are the indices of the output wires of the circuit.

Garbling can also be used for multiparty computation (MPC). Specifically, N parties can collaboratively take the role of the garbler and compute the garbling procedures described above to generate and output the garbled circuit (the collection of garbled gates). In addition, the N parties can collaboratively output a single key per input wire, and every party can take the role of the evaluator on its own and obtain the evaluation of the circuit.

Garbling techniques can be performed using a different N-party MPC protocol that involves picking two random labels per wire and then computing the garbled gates as described above. For example, such a protocol may output a single label per input wire and the map associated with each output wire. These actions may be performed without any of the parties knowing the private inputs of the other parties. Finally, given a single label per input wire, all garbled gates, and the maps for the output wires, each party can take the role of the evaluator and obtain the output of the circuit on the private inputs.

In many cases, the efficiency of an MPC protocol is measured by the complexity of the underlying garbling scheme that must be computed. Typically in N-party MPC, linear operations are computed ‘for free’ (without communication) whereas non-linear ones are costly (require communication). For example, a multiplication of a public matrix with a vector of secrets is a linear operation whereas multiplication of two secrets is a non-linear operation. Therefore, when measuring the efficiency of a garbling scheme in the multiparty setting, the number of non-linear operations (multiplication of secrets) required to obtain the garbled gates may be counted.

Existing garbling schemes do not support efficient instantiation inside another MPC protocol and, as such, state of the art protocols for N-party garbling do not follow the modular approach described above. Instead, they follow a special protocol that is tailored specifically for the N-party case. For each gate in the circuit, these protocols perform O(N) secure multiplications in the garbling phase and produce a garbled table of size O(N) ciphertexts (as opposed to 4 ciphertexts in the modular approach). Moreover, the evaluation incurs O(N²) computational overhead. This makes existing N-party garbling protocols difficult to scale when the number of parties (N) is large. While certain N-party garbling protocols with asymptotic overheads similar to those achieved by the modular approach have been proposed, these protocols rely on a highly inefficient primitive called homomorphic pseudorandom function (PRF). Thus, so far there is no implementation of these previously-proposed protocols.

### Improved Garbling Techniques

To address the issues identified above with existing garbling techniques, embodiments of the present disclosure involve a new, simpler, garbling scheme. In particular, the improved garbling techniques described herein can be performed efficiently even for a large number of parties. Specifically, the underlying MPC that computes the garbled gates according to certain embodiments of the present disclosure involves computing O(|H|) multiplications, which is independent of N. This is also the computation complexity of the parties per gate. Furthermore, techniques described herein involve the use of a function H that is fully linear. That is, H(x) is simply M·x where M is a public matrix and x is a secret vector. Thus, techniques described herein do not require any communication in the underlying MPC protocol.

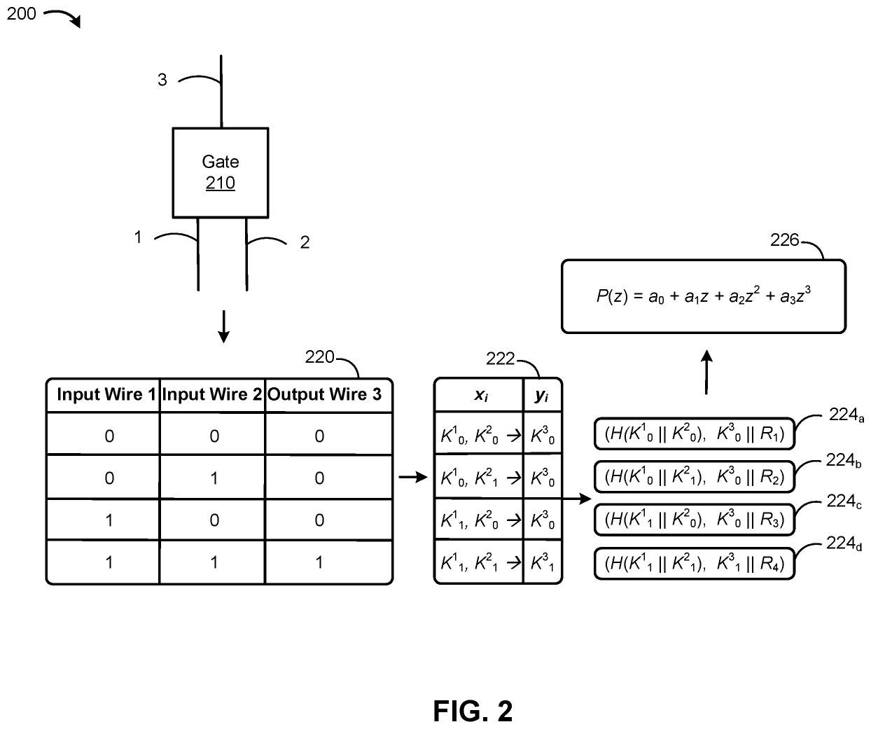

The improved garbling scheme proposed herein (described in more detail below with respect to FIGS. 2-4) is much simpler than existing garbling schemes and relies in certain embodiments on a pre-image resistant hash function (PRHF). Specifically, a PRHF is a function that is easy to compute but difficult to invert. That is, for a PRHF F, given y=F(x) it is difficult (practically impossible) to find x. Furthermore, the improved garbling scheme set forth herein involves the use of polynomial interpolation to produce a polynomial for each gate in a circuit. Computation of polynomials is a fully linear operation, and, when performed in an underlying MPC protocol it requires a communication amount that is proportional to the polynomial degree, which is constant in techniques described herein.

Thus, overall, applying the improved garbling techniques described herein to the multiparty setting incurs O(1) non-linear operations (for picking random labels and interpolating the degree-3 polynomial) and O(|H|) computation. Since this is independent of the number of parties, techniques described herein outperform all existing garbling schemes in the multiparty setting when Nis large (e.g., including tens of parties).

Improved garbling techniques involving polynomial interpolation and/or hash functions are described in more detail below with respect to FIGS. 2-4 and can be utilized for data security as described in more detail below with respect to FIG. 1.

FIG. 1 is an illustration 100 of example computing components related to data security.

In illustration 100, a client device 120, a server 130, and a cloud 150 are connected via a network 110. Network 110 may, for example, be a local area network (LAN) a wide area network (WAN), and/or the like. Client device 120 and server 130 may each be computing devices with one or more processors, memory, and/or the like, and/or may be implemented as software running on one or more physical computing devices with one or more processors, memory, and/or the like. Cloud 150 generally represents a cloud computing environment comprising one or more computing devices with one or more processors, memory, and/or the like, and/or may comprise software running on one or more physical computing devices with one or more processors, memory, and/or the like. Client device 120 generally represents a computing device (e.g., desktop or laptop computer, mobile device, virtual computing instance, and/or the like) associated with a user of one or more software applications. For example, client device 120 may store sensitive data associated with the user for which certain processing is desired while maintaining the security of the data.

In a particular example, client device 120 monitors activity of the user, and the activity data is not to be disclosed to cloud 150 (and/or, in some embodiments, server 130). Server 130 may comprise software that analyzes user data in order to provide some service (e.g., monitoring of user health data to detect potential emergencies, recommending content to the user based on activity data, determining solutions to technical issues based on activity data, and/or the like). Cloud 150 may provide processing and/or storage resources, and server 130 may utilize cloud 150 to perform computation and/or storage related to processing user data (e.g., in order to offload processing and/or storage tasks from server 130 for improved efficiency of server 130, to complete processing more efficiently, and/or for fault tolerance purposes). For example, server 130 may provide one or more components of its code to cloud 150 so that computations can be performed by cloud 150. While aspects of the user data stored on client device 120 may be provided to server 130 (e.g., in encrypted form as encrypted data 122 to reduce risk of inadvertent exposure of the data during transmission), cloud 150 may not be maintained by a trusted party, and so transmission of user data to cloud 150 may be considered insecure.

In order to implement an improved garbling scheme described herein, a garbling component 140 is located on server 130 and an evaluator component 160 is located on cloud 150. Garbling component 140 may be referred to as the garbler, while evaluator component 160 may be referred to as the evaluator.

Garbling component 140 generates a garbled function 126 using techniques described herein based on a function 142 stored on server 130. For instance, function 142 may represent a circuit with one or more gates, and garbled function 126 may be a garbled version of the circuit including garbled versions of the one or more gates based on garbling techniques described herein. In an example, function 142 is a function that performs evaluation of user data to determine an output (e.g., whether or not some condition is indicated by the user data).

As described in more detail below with respect to FIG. 2, garbling component 140 may use polynomial interpolation and/or a second-preimage resistant hash function (SPRHF) to generate garbled function 126 in a resource-efficient manner such that garbled function 126 can be evaluated in a resource-efficient manner while providing a high level of data security. Garbled function 126 can be evaluated using garbled inputs in order to produce a garbled output, which may be translated into an actual output 128 using a map of garbled outputs to actual output values (e.g., 0 or 1). The map may be provided by garbling component 140 to evaluator component 160 along with garbled function 126. In an example, evaluator component 160 may receive garbled data 124 from client device 120, and may use garbled data 124 to provide one or more garbled inputs to garbled function 126. In one particular example, garbling component 140 sends garbling logic to client device 120, and client device 120 uses the garbling logic to generate garbled data 124 based on user data stored on client device 120.

In alternative embodiments, client device 120 and server 130 collectively perform the logic of garbling component 140, such as computing garbled function 126 together (e.g., each computing different garbled gates).

Evaluator component 160 provides output 128 to garbling component 140. As such, garbling component 140 is able to obtain the output 128 of applying function 142 to user data from cloud 150 without server 130 needing to have access to the user data and/or without cloud 150 having access to the original function 142 or the user data in an un-garbled form.

Details of the garbling logic are described below with respect to FIG. 2. It is noted that the components and arrangement depicted in FIG. 1 are included as an example, and garbling techniques described herein may be used in a plurality of different contexts, with different components and/or different arrangements. For example, functionality described herein may be performed by one or more additional or fewer components, located on the same and/or different computing devices.

FIG. 2 is an illustration 200 of an example related to an improved garbling algorithm for data security. For example, logic depicted and described with respect to FIG. 2 may be performed by garbling component 140 (the garbler) and/or evaluator component 160 (the evaluator) of FIG. 1.

A gate 210 represents a logical gate in a circuit. For example, gate 210 may be one of a plurality of gates included in function 142 of FIG. 1. Gate 210 has input wires 1 and 2 and an output wire 3. Gates in function 142 of FIG. 1 may include AND (∧) gates and/or XOR (∨) gates. In illustration 200, gate 210 is an AND gate.

Output table 220 indicates the values of output wire 3 of gate 210 for each combination of values for input wires 1 and 2. The example depicted in output table 220 represents AND logic. When the values of input wires 1 and 2 are (0, 0) then output wire 3 has a value of 0. When the values of input wires 1 and 2 are (0, 1) then output wire 3 has a value of 0. When the values of input wires 1 and 2 are (1, 0) then output wire 3 has a value of 0. When the values of input wires 1 and 2 are (1, 1) then output wire 3 has a value of 1.

According to improved garbling techniques described herein, for every wire j in the circuit, the garbler chooses two random labels K^{j}₀ and K^{j}₁. For example, the garbler may determine random labels K¹₀ and K¹₁ for input wire 1, random labels K²₀ and K²₁ for input wire 2, and random labels K³₀ and K³₁ for output wire 3. The random labels may be randomly generated bit strings.

For each gate g (with function g(⋅)∈{∧, ∨}), a and b are g's input wires and c is its output wire. In some embodiments, the garbler defines the following four interpolation points for each gate g:

(x₁,y₁)=(H(K^{a}₀∥K^{b}₀),K^{c}_{g(0,0)})

(x₂,y₂)=(H(K^{a}₀∥K^{b}₁),K^{c}_{g(0,1)})

(x₃,y₃)=(H(K^{a}₁∥K^{b}₀),K^{c}_{g(1,0)})

(x₄,y₄)=(H(K^{a}₁∥K^{b}₁),K^{c}_{g(1,1)}),

where ∥ is a concatenation operation, H is a secondary pre-image resistant hash function (SPRHF), and g(⋅) represents the result of evaluating gate g with given values for its input wires. A pre-image resistant hash function (PRHF) is a function that is easy to compute but difficult to invert. That is, for a PRHF F, given y=F(x) it is difficult (practically impossible) to find x. As is known in the art, an SPRHF is stronger than PRHF in the sense that it is difficult to find a new preimage even when an adversary already has one at hand.

In other embodiments, the garbler defines the following four interpolation points for each gate g:

(x₁,y₁)=H(K^{a}₀∥K^{b}₀),K^{c}_{g(0,0)}∥R₁)

(x₂,y₂)=H(K^{a}₀∥K^{b}₁),K^{c}_{g(0,1)}∥R₂)

(x₃,y₃)=H(K^{a}₁∥K^{b}₀),K^{c}_{g(1,0)}∥R₃)

(x₄,y₄)=H(K^{a}₁∥K^{b}₁),K^{c}_{g(1,1)}∥R₄),

where R₁, R₂, R₃, and R₄ are randomly generated values (e.g., bit strings). For example, randomly generated values may be concatenated to the y coordinate of each interpolation point for added security (e.g., to prevent the evaluator from inferring private input values based on output values).

As shown in table 222, the values of interpolation points (xᵢ, yᵢ) for i∈{1, 2, 3, 4} may be based on output table 220 and the random labels assigned to 0 and 1 for each wire. For example, x₁ is based on K¹₀ and K²₀ and y₁ is based on y³₀. Similarly, x₂ is based on K¹₀ and K²₁ and y₂ is based on y³₀. Additionally, x₃ is based on K¹₁ and K²₀ and y₃ is based on y³₀. Finally, x₄ is based on K¹₁ and K²₁ and y₄ is based on y³₁. For example, the y values may be based on concatenating the labels of the two input wires. In some embodiments, a hash function (e.g., an SPRHF) is also applied to the concatenation of the labels of the two input wires to produce the y value. In certain embodiments the corresponding label for the output wire is concatenated to a randomly generated value to generate each y value.

Thus, in the example depicted in illustration 200, interpolation point 224ₐ is determined to be (H(K¹₀∥K²₀), K³₀∥R₁), interpolation point 224_{b} is determined to be (H(K¹₀∥K²₁), K³₀∥R₂), interpolation point 224, is determined to be (H(K¹∥K²₀), K³₀∥R₃), and interpolation point 224ₐ is determined to be (H(K¹∥K²₁), K³₁∥R₄). It is noted that the use of a hash function for they values and the concatenation of randomly-generated values (R₁, R₂, R₃, and R₄) for the x values of interpolation points 224 are optional enhancements, and techniques described herein may be utilized without these enhancements.

According to certain embodiments, the garbler determines a degree-3 polynomial, P_{g}, that ‘agrees’ with the four interpolation points (e.g., interpolation points 224). Specifically, P_{g}(xᵢ)=yᵢ for i∈{1, 2, 3, 4}. Such a polynomial may be determined through polynomial interpolation (also referred to as linear interpolation), which is a technique known in the art. The polynomial P_{g} is considered a garbled gate for g.

Thus, polynomial 225 is determined based on interpolation points 224 using polynomial interpolation, and represents a garbled gate for gate 210. Polynomial 225 is represented as P(z)=a₀+a₁z+a₂z²+a₃z³, where P(z)=yᵢ when z=xᵢ.

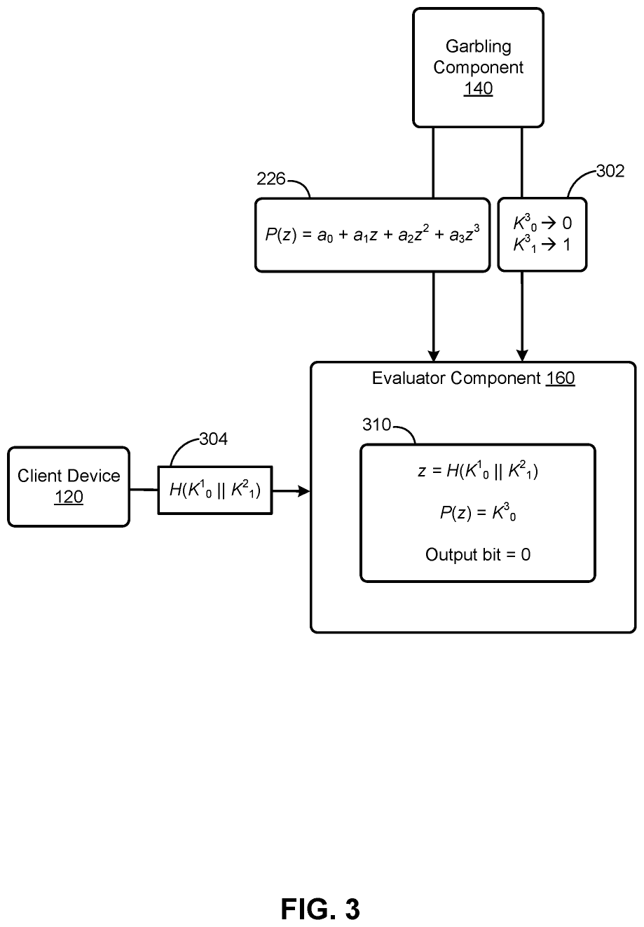

As described in more detail below with respect to FIG. 3, the garbler may provide polynomial 226 to the evaluator along with a map of K³₀ to 0 and K³₁ to 1. The garbler may also determine corresponding polynomials for other gates in the circuit and provide those polynomials and corresponding output maps to the evaluator as well. The evaluator may use polynomial 226 (and any polynomials for other gates) along with the mapping information to determine an output of gate 210 (and any other gates in the circuit) based on garbled inputs (e.g., labels for values provided to input wires that are determined by some computing entity based on private data that is not provided to the evaluator).

For example, in some embodiments the garbler sends the polynomials P_{g} for all gates g in the circuit to the evaluator. This list of polynomials is considered the garbled circuit. The garbler also sends to the evaluator the map mapⱼ={K^{j}₀→0, K^{j}₁→1} for every output wire j. The evaluator obtains one label for every input wire j (e.g., from a client device and/or one or more other computing components). Given the garbled circuit {P_{g}}g for all gates g, the maps {mapⱼ}ⱼ for all output wires j, and the labels {Kⱼ}ⱼ for all input wires j, the evaluator evaluates the circuit as follows. For every gate g with input wires a and b and output wire c the evaluator computes k^{c}=P_{g}(H(K^{a}∥K^{b})). After evaluating all gates, for every output wire j, the evaluator computes the bit yⱼ=mapⱼ(K).

FIG. 3 is an illustration 300 of an additional example related to an improved garbling algorithm for data security. FIG. 3 includes client device 120, garbling component 140, and evaluator component 160 of FIG. 1 and polynomial 226 of FIG. 2.

Garbling component 140 provides polynomial 226 and a map 302 to evaluator component 160. Map 302 indicates that K³₀ corresponds to 0 and that K³₁ corresponds to 1.

Client device 120 provides a garbled input 304 to evaluator component. For example, garbled input 304 represents an input value to polynomial 226 that is determined based on private data stored on client device 120. In one example, garbling component 140 sends information to client device 120 that allows client device 120 to generate garbled input 304 based on private data. For example, garbling component 140 may send client device 120 hash function H and/or maps of K¹₀ to 0, K¹₁ to 1, K²₀ to 0, and/or K²₁ to 1. Client device 120 determines garbled input 304 by determining the labels K¹₀ and K²₁ that correspond to private inputs to wires 1 and 2, concatenating K¹₀ and K² together, and applying hash function H to the concatenated result.

In alterative embodiments, garbling component 140 and/or one or more other computing components determine garbled input 304 and provide garbled input 304 to evaluator component 160.

Evaluator component 160 performs evaluation 310 of polynomial 226 based on garbled input 304. For example, evaluation 310 involves setting z equal to garbled input 304 (which is H(K¹₀∥K²₁)), evaluating P(z) accordingly to produce a result of K³₀, and determining that the output bit is 0 based on mapping 302, which indicates that K³₀ corresponds to 0.

Thus, according to embodiments, of the present disclosure, evaluator component 160 is able to determine an output bit for a function with a given input value without having access to the original function or the given input value.

In some embodiments, evaluator component 160 sends the output bit of 0 and/or K³₀ to garbling component 140 and/or to one or more other components.

Given the points (xᵢ, yᵢ) for i∈{1, 2, 3, 4} computing P_{g} is a fully linear operation (linear interpolation), and thus, when computed in an underlying MPC protocol, this operation does not require communication. In addition, certain embodiments involve using a hash function H that is fully linear. Thus, overall, applying garbling techniques described herein to a multiparty setting incurs O(1) non-linear operations (for picking random labels, as computing the garbled gate itself does not incur non-linear operations) and O(|H|) computation. Since this is independent of the number of parties, techniques described herein outperform existing garbling techniques in the multiparty setting, particularly when N is large (e.g., including tens of parties). In particular, embodiments of the present disclosure improve the functioning of computing devices involved by requiring fewer compute cycles than existing garbling techniques and producing results more quickly than existing garbling techniques.

In an example, employing garbling techniques described herein to securely compute the result of a function on one or more private input values allows such computation to be performed with the use of fewer processing resources than existing garbling techniques, and allows the output of the function to be produced with greater speed than existing garbling techniques.

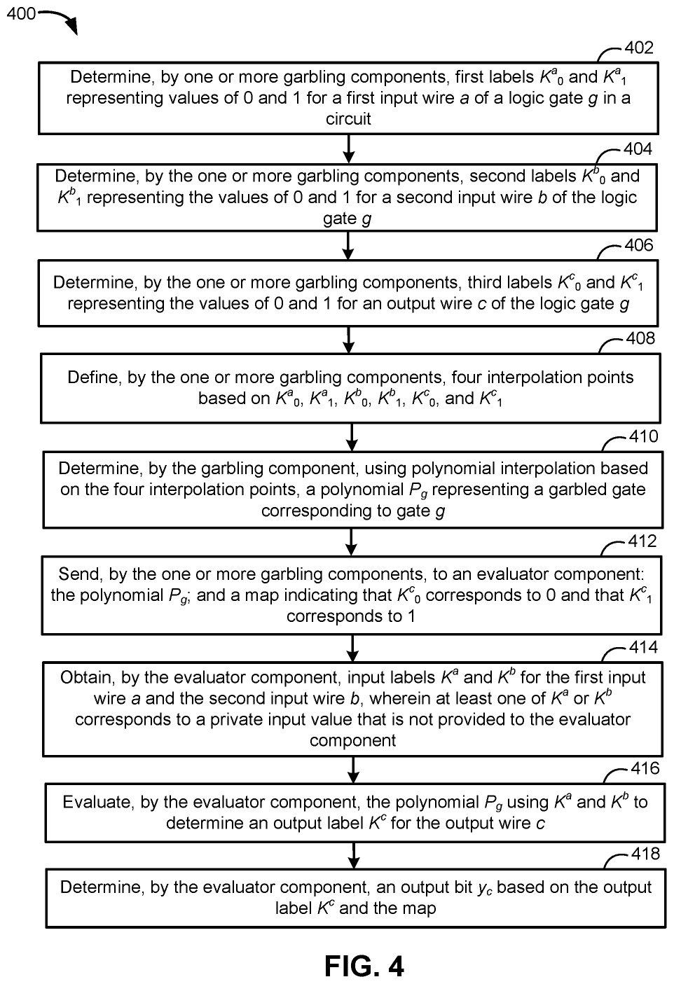

FIG. 4 depicts example operations 400 related to data security. For example, operations 400 may be performed by one or more components of server 130, cloud 150, and/or client device 120 of FIG. 1, such as garbling component 140 and/or evaluator component 160.

Operations 400 begin at step 402, with determining, by one or more garbling components, first labels K^{a}₀ and K^{a}₁ representing values of 0 and 1 for a first input wire a of a gate g in a circuit. The gate may, for example, be one of an AND gate or an exclusive OR (XOR) gate.

Operations 400 continue at step 404, with determining, by the one or more garbling components, second labels K^{b}₀ and K^{b}₁ representing the values of 0 and 1 for a second input wire b of the gate g.

Operations 400 continue at step 406, with determining, by the one or more garbling components, third labels K^{c}₀ and K^{c}₁ representing the values of 0 and 1 for an output wire c of the gate g.

Operations 400 continue at step 408, with defining, by the one or more garbling components, four interpolation points based on K^{a}₀, K^{a}₁, K^{b}₀, K^{b}₁, K^{c}₀, and K^{c}₁.

In some embodiments, the four interpolation points comprise a first interpolation point (x₁, y₁) wherein x₁ is based on Kao and K^{b}₀ and y₁ is based on K^{c}₀ or K^{c}₁, a second interpolation point (x₂, y₂) wherein x₂ is based on K^{a}₀ and K^{b}₁ and y₂ is based on K^{c}₀ or K^{c}₁, a third interpolation point (x₃, y₃) wherein x₃ is based on K^{a}₁ and K^{b}₀ and y₃ is based on K^{c}₀ or K^{c}₁, and a fourth interpolation point (x₄, y₄) wherein x₄ is based on K^{a}₁ and K^{b}₁ and y₄ is based on K^{c}₀ or K^{c}₁.

For example, x₁ may be determined by applying a hash function H to a concatenation of K^{a}₀ and K^{b}₀, x₂ may be determined by applying the hash function H to a concatenation of K^{a}₀ and K^{b}₁, x₃ may be determined by applying the hash function H to a concatenation of K^{a}₁ and K^{b}₀, and x₄ may be determined by applying the hash function H to a concatenation of K^{a}₁ and K^{b}₁. In some embodiments, the hash function H is a second-preimage resistant hash function (SPRHF).

In certain embodiments, y₁ is determined based on concatenating a first random value R₁ with K^{c}₀ or K^{c}₁, y₂ is determined based on concatenating a second random value R₂ with K^{c}₀ or K^{c}₁, y₃ is determined based on concatenating a third random value R₃ with K^{c}₀ or K^{c}₁, and y₄ is determined based on concatenating a fourth random value R₄ with K^{c}₀ or K^{c}₁.

Operations 400 continue at step 410, with determining, by the garbling component, using polynomial interpolation based on the four interpolation points, a polynomial P_{g} representing a garbled gate corresponding to gate g.

Operations 400 continue at step 412, with sending, by the one or more garbling components, to an evaluator component: the polynomial P_{g}; and a map indicating that K^{c}₀ corresponds to 0 and that K^{c}₁ corresponds to 1.

Operations 400 continue at step 414, with obtaining, by the evaluator component, input labels K^{a} and K^{b} for the first input wire a and the second input wire b, wherein at least one of K^{a} or K^{b} corresponds to a private input value that is not provided to the evaluator component.

Operations 400 continue at step 416, with evaluating, by the evaluator component, the polynomial P_{g} using K^{a} and K^{b} to determine an output label K^{c} for the output wire c.

Operations 400 continue at step 418, with determining, by the evaluator component, an output bit y_{c} based on the output label K^{c} and the map.

Some embodiments further comprise receiving, by the evaluator component, from an additional one or more garbling components, an additional polynomial Pₘ representing an additional garbled gate corresponding to an additional gate m of the circuit, wherein the evaluator component determines an overall output for the circuit based on y_{c} and a result of evaluating Pₘ.

The various embodiments described herein may employ various computer-implemented operations involving data stored in computer systems. For example, these operations may require physical manipulation of physical quantities-usually, though not necessarily, these quantities may take the form of electrical or magnetic signals, where they or representations of them are capable of being stored, transferred, combined, compared, or otherwise manipulated. Further, such manipulations are often referred to in terms, such as producing, identifying, determining, or comparing. Any operations described herein that form part of one or more embodiments of the invention may be useful machine operations. In addition, one or more embodiments of the invention also relate to a device or an apparatus for performing these operations. The apparatus may be specially constructed for specific required purposes, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The various embodiments described herein may be practiced with other computer system configurations including hand-held devices, microprocessor systems, microprocessor-based or programmable consumer electronics, minicomputers, mainframe computers, and/or the like.

One or more embodiments of the present invention may be implemented as one or more computer programs or as one or more computer program modules embodied in one or more computer readable media. The term computer readable medium refers to any data storage device that can store data which can thereafter be input to a computer system-computer readable media may be based on any existing or subsequently developed technology for embodying computer programs in a manner that enables them to be read by a computer. Examples of a computer readable medium include a hard drive, network attached storage (NAS), read-only memory, random-access memory (e.g., a flash memory device), a CD (Compact Discs)—CD-ROM, a CD-R, or a CD-RW, a DVD (Digital Versatile Disc), a magnetic tape, and other optical and non-optical data storage devices. The computer readable medium can also be distributed over a network coupled computer system so that the computer readable code is stored and executed in a distributed fashion.

Although one or more embodiments of the present invention have been described in some detail for clarity of understanding, it will be apparent that certain changes and modifications may be made within the scope of the claims. Accordingly, the described embodiments are to be considered as illustrative and not restrictive, and the scope of the claims is not to be limited to details given herein, but may be modified within the scope and equivalents of the claims. In the claims, elements and/or steps do not imply any particular order of operation, unless explicitly stated in the claims.

Virtualization systems in accordance with the various embodiments may be implemented as hosted embodiments, non-hosted embodiments or as embodiments that tend to blur distinctions between the two, are all envisioned. Furthermore, various virtualization operations may be wholly or partially implemented in hardware. For example, a hardware implementation may employ a look-up table for modification of storage access requests to secure non-disk data.

Certain embodiments as described above involve a hardware abstraction layer on top of a host computer. The hardware abstraction layer allows multiple contexts to share the hardware resource. In one embodiment, these contexts are isolated from each other, each having at least a user application running therein. The hardware abstraction layer thus provides benefits of resource isolation and allocation among the contexts. In the foregoing embodiments, virtual machines are used as an example for the contexts and hypervisors as an example for the hardware abstraction layer. As described above, each virtual machine includes a guest operating system in which at least one application runs. It should be noted that these embodiments may also apply to other examples of contexts, such as containers not including a guest operating system, referred to herein as “OS-less containers” (see, e.g., www.docker.com). OS-less containers implement operating system-level virtualization, wherein an abstraction layer is provided on top of the kernel of an operating system on a host computer. The abstraction layer supports multiple OS-less containers each including an application and its dependencies. Each OS-less container runs as an isolated process in userspace on the host operating system and shares the kernel with other containers. The OS-less container relies on the kernel's functionality to make use of resource isolation (CPU, memory, block I/O, network, etc.) and separate namespaces and to completely isolate the application's view of the operating environments. By using OS-less containers, resources can be isolated, services restricted, and processes provisioned to have a private view of the operating system with their own process ID space, file system structure, and network interfaces. Multiple containers can share the same kernel, but each container can be constrained to only use a defined amount of resources such as CPU, memory and I/O. The term “virtualized computing instance” as used herein is meant to encompass both VMs and OS-less containers.

Many variations, modifications, additions, and improvements are possible, regardless the degree of virtualization. The virtualization software can therefore include components of a host, console, or guest operating system that performs virtualization functions. Plural instances may be provided for components, operations or structures described herein as a single instance. Boundaries between various components, operations and data stores are somewhat arbitrary, and particular operations are illustrated in the context of specific illustrative configurations. Other allocations of functionality are envisioned and may fall within the scope of the invention(s). In general, structures and functionality presented as separate components in exemplary configurations may be implemented as a combined structure or component. Similarly, structures and functionality presented as a single component may be implemented as separate components. These and other variations, modifications, additions, and improvements may fall within the scope of the appended claim(s).

What is claimed is:

1. A method of data security, comprising:
determining, by one or more garbling components running on one or more processing devices:
first labels K^{a}₀ and K^{a}₁ representing values of 0 and 1 for a first input wire a of a gate g in a circuit;
second labels K^{b}₀ and K^{b}₁ representing the values of 0 and 1 for a second input wire b of the gate g; and
third labels K^{c}₀ and K^{c}₁ representing the values of 0 and 1 for an output wire c of the gate g;
defining, by the one or more garbling components, four interpolation points based on K^{a}₀, K^{a}₁, K^{b}₀, K^{b}₁, K^{c}₀, and K^{c}₁;
determining, by the garbling component, using polynomial interpolation based on the four interpolation points, a polynomial P_{g} representing a garbled gate corresponding to gate g;
sending, by the one or more garbling components, to an evaluator component running on one or more additional processing devices:
the polynomial P_{g}; and
a map indicating that K^{c}₀ corresponds to 0 and that K^{c}₁ corresponds to 1;
obtaining, by the evaluator component, input labels K^{a} and K^{b} for the first input wire a and the second input wire b, wherein at least one of K^{a} or K^{b} corresponds to a private input value that is not provided to the evaluator component;
evaluating, by the evaluator component, the polynomial P_{g} using K^{a} and K^{b} to determine an output label K^{c} for the output wire c; and
determining, by the evaluator component, an output bit y_{c} based on the output label K^{c} and the map.

2. The method of claim 1, wherein the four interpolation points comprise:
a first interpolation point (x₁, y₁), wherein:
x₁ is based on K^{a}₀ and K^{b}₀; and
y₁ is based on K^{c}₀ or K^{c}₁;
a second interpolation point (x₂, y₂), wherein:
x₂ is based on Kao and K^{b}₁; and
y₂ is based on K^{c}₀ or K^{c}₁;
a third interpolation point (x₃, y₃), wherein:
x₃ is based on K^{a}₁ and K^{b}₀; and
y₃ is based on K^{c}₀ or K^{c}₁; and
a fourth interpolation point (x₄, y₄), wherein:
x₄ is based on K^{a}₁ and K^{b}₁; and
y₄ is based on K^{c}₀ or K^{c}₁.

3. The method of claim 2, wherein:
x₁ is determined by applying a hash function H to a concatenation of K^{a}₀ and K^{b}₀;
X₂ is determined by applying the hash function H to a concatenation of K^{a}₀ and K^{b}₁;
X₃ is determined by applying the hash function H to a concatenation of K^{a}₁ and K^{b}₀; and
x₄ is determined by applying the hash function H to a concatenation of K^{a}₁ and K^{b}₁.

4. The method of claim 3, wherein the hash function H is a second-preimage resistant hash function (SPRHF).

5. The method of claim 2, wherein:
y₁ is determined based on concatenating a first random value R₁ with K^{c}₀ or K^{c}₁;
y₂ is determined based on concatenating a second random value R₂ with K^{c}₀ or K^{c}₁;
y₃ is determined based on concatenating a third random value R₃ with K^{c}₀ or K^{c}₁; and
y₄ is determined based on concatenating a fourth random value R₄ with K^{c}₀ or K^{c}₁.

6. The method of claim 1, further comprising receiving, by the evaluator component, from an additional one or more garbling components, an additional polynomial Pₘ representing an additional garbled gate corresponding to an additional gate m of the circuit, wherein the evaluator component determines an overall output for the circuit based on y_{c} and a result of evaluating Pₘ.

7. The method of claim 1, wherein the gate g is one of:
an AND gate; or
an exclusive OR (XOR) gate.

8. A system for data security, the system comprising:
at least one memory; and
at least one processor coupled to the at least one memory, the at least one processor and the at least one memory configured to:
determine, by one or more garbling components running on one or more processing devices:
first labels K^{a}₀ and K^{a}₁ representing values of 0 and 1 for a first input wire a of a gate g in a circuit;
second labels K^{b}₀ and K^{b}₁ representing the values of 0 and 1 for a second input wire b of the gate g; and
third labels K^{c}₀ and K^{c}₁ representing the values of 0 and 1 for an output wire c of the gate g;
define, by the one or more garbling components, four interpolation points based on K^{a}₀, K^{a}₁, K^{b}₀, K^{b}₁, K^{c}₀, and K^{c}₁;
determine, by the garbling component, using polynomial interpolation based on the four interpolation points, a polynomial P_{g} representing a garbled gate corresponding to gate g;
send, by the one or more garbling components, to an evaluator component running on one or more additional processing devices:
the polynomial P_{g}; and
a map indicating that K^{c}₀ corresponds to 0 and that K^{c}₁ corresponds to 1;
obtain, by the evaluator component, input labels K^{a} and K^{b} for the first input wire a and the second input wire b, wherein at least one of K^{a} or K^{b} corresponds to a private input value that is not provided to the evaluator component;
evaluate, by the evaluator component, the polynomial P_{g} using K^{a} and K^{b} to determine an output label K^{c} for the output wire c; and
determine, by the evaluator component, an output bit y_{c} based on the output label K^{c} and the map.

9. The system of claim 8, wherein the four interpolation points comprise:
a first interpolation point (x₁, y₁), wherein:
x₁ is based on Kao and K^{b}₀; and
y₁ is based on K^{c}₀ or K^{c}₁;
a second interpolation point (x₂, y₂), wherein:
x₂ is based on Kao and K^{b}₁; and
y₂ is based on K^{c}₀ or K^{c}₁;
a third interpolation point (x₃, y₃), wherein:
x₃ is based on K^{a}₁ and K^{b}₀; and
y₃ is based on K^{c}₀ or K^{c}₁; and
a fourth interpolation point (x₄, y₄), wherein:
x₄ is based on K^{a}₁ and K^{b}₁; and
y₄ is based on K^{c}₀ or K^{c}₁.

10. The system of claim 9, wherein:
x₁ is determined by applying a hash function H to a concatenation of K^{a}₀ and K^{b}₀;
x₂ is determined by applying the hash function H to a concatenation of K^{a}₀ and K^{b}₁;
X₃ is determined by applying the hash function H to a concatenation of K^{a}₁ and K^{b}₀; and
x₄ is determined by applying the hash function H to a concatenation of K^{a}₁ and K^{b}₁.

11. The system of claim 10, wherein the hash function H is a second-preimage resistant hash function (SPRHF).

12. The system of claim 9, wherein:
y₁ is determined based on concatenating a first random value R₁ with K^{c}₀ or K^{c}₁;
y₂ is determined based on concatenating a second random value R₂ with K^{c}₀ or K^{c}₁;
y₃ is determined based on concatenating a third random value R₃ with K^{c}₀ or K^{c}₁; and
y₄ is determined based on concatenating a fourth random value R₄ with K^{c}₀ or K^{c}₁.

13. The system of claim 8, wherein the at least one processor and the at least one memory are further configured to receive, by the evaluator component, from an additional one or more garbling components, an additional polynomial Pₘ representing an additional garbled gate corresponding to an additional gate m of the circuit, wherein the evaluator component determines an overall output for the circuit based on y_{c} and a result of evaluating Pₘ.

14. The system of claim 8, wherein the gate g is one of:
an AND gate; or
an exclusive OR (XOR) gate.

15. A non-transitory computer-readable medium storing instructions that, when executed by one or more processors, cause the one or more processors to:
determine, by one or more garbling components running on one or more processing devices:
first labels K^{a}₀ and K^{a}₁ representing values of 0 and 1 for a first input wire a of a gate g in a circuit;
second labels K^{b}₀ and K^{b}₁ representing the values of 0 and 1 for a second input wire b of the gate g; and
third labels K^{c}₀ and K^{c}₁ representing the values of 0 and 1 for an output wire c of the gate g;
define, by the one or more garbling components, four interpolation points based on K^{a}₀, K^{a}₁, K^{b}₀, K^{b}₁, K^{c}₀, and K^{c}₁;
determine, by the garbling component, using polynomial interpolation based on the four interpolation points, a polynomial P_{g} representing a garbled gate corresponding to gate g;
send, by the one or more garbling components, to an evaluator component running on one or more additional processing devices:
the polynomial P_{g}; and
a map indicating that K^{c}₀ corresponds to 0 and that K^{c}₁ corresponds to 1;
obtain, by the evaluator component, input labels K^{a} and K^{b} for the first input wire a and the second input wire b, wherein at least one of K^{a} or K^{b} corresponds to a private input value that is not provided to the evaluator component;
evaluate, by the evaluator component, the polynomial P_{g} using K^{a} and K^{b} to determine an output label K^{c} for the output wire c; and
determine, by the evaluator component, an output bit y_{c} based on the output label K^{c} and the map.

16. The non-transitory computer-readable medium of claim 15, wherein the four interpolation points comprise:
a first interpolation point (x₁, y₁), wherein:
x₁ is based on K^{a}₀ and K^{b}₀; and
y₁ is based on K^{c}₀ or K^{c}₁;
a second interpolation point (x₂, y₂), wherein:
x₂ is based on K^{a}₀ and K^{b}₁; and
y₂ is based on K^{c}₀ or K^{c}₁;
a third interpolation point (x₃, y₃), wherein:
x₃ is based on K^{a}₁ and K^{b}₀; and
y₃ is based on K^{c}₀ or K^{c}₁; and
a fourth interpolation point (x₄, y₄), wherein:
x₄ is based on K^{a}₁ and K^{b}₁; and
y₄ is based on K^{c}₀ or K^{c}₁.

17. The non-transitory computer-readable medium of claim 16, wherein:
x₁ is determined by applying a hash function H to a concatenation of K^{a}₀ and K^{b}₀;
x₂ is determined by applying the hash function H to a concatenation of K^{a}₀ and K^{b}₁;
X₃ is determined by applying the hash function H to a concatenation of K^{a}₁ and K^{b}₀; and
x₄ is determined by applying the hash function H to a concatenation of K^{a}₁ and K^{b}₁.

18. The non-transitory computer-readable medium of claim 17, wherein the hash function H is a second-preimage resistant hash function (SPRHF).

19. The non-transitory computer-readable medium of claim 16, wherein:
y₁ is determined based on concatenating a first random value R₁ with K^{c}₀ or K^{c}₁;
y₂ is determined based on concatenating a second random value R₂ with K^{c}₀ or K^{c}₁;
y₃ is determined based on concatenating a third random value R₃ with K^{c}₀ or K^{c}₁; and
y₄ is determined based on concatenating a fourth random value R₄ with K^{c}₀ or K^{c}₁.

20. The non-transitory computer-readable medium of claim 15, wherein the instructions, when executed by the one or more processors, further cause the one or more processors to receive, by the evaluator component, from an additional one or more garbling components, an additional polynomial Pₘ representing an additional garbled gate corresponding to an additional gate m of the circuit, wherein the evaluator component determines an overall output for the circuit based on y_{c} and a result of evaluating Pₘ.
